(19) United States
(12) Patent Application Publication
(10) Pub. No.: US 2004/0169643 A1
(43) Pub. Date: Sep. 2, 2004

(54) Touch panel and method for fabricating the same

(76) Inventor: Kuo-Hao Tseng, Taipei (TW)

Correspondence Address: Michael D. Bednarek, Shaw Pittman LLP, 1650 Tysons Boulevard, McLean, VA, 22102, US

(21) Appl. No.: 10/373,769

(22) Filed: Feb. 27, 2003

(51) Int. Cl. G09G 5/00

(52) U.S. Cl. 345/173

(57) ABSTRACT

A touch panel and a method for fabricating the same are disclosed. The touch panel comprises: a substrate, a first resistive layer formed on the substrate, a cover sheet disposed above the substrate with a gap, a second resistive layer formed on the cover sheet, and a plurality of insulative spacers formed within the gap between the cover sheet and the substrate. The first resistive layer is divided into a first active region and a first peripheral region by a first trench, and the second resistive layer is divided into a second active region and a second peripheral region by a second trench. According to the present invention, the formation of the trenches is laser-patterned without subject to photolithographic and etching processes. Thus, the issues of complicated process, device lifetime shortening, and production yield deterioration can be avoided.

### BACKGROUND OF THE INVENTION

1. Field of the Invention

The present invention generally relates to a touch panel and a method for fabricating the same. More particular, the present invention relates to a resistive touch panel which can be fabricated by means of inexpensive processes.

2. Description of Related Arts

Touch panels, in conjunction with liquid crystal displays (LCD) or cathode ray tube (CRT) displays, are becoming a user input interface with computers. The touch panel allows people to easily interact with the computer without keyboards or mice. Referring to FIGS. 1˜3, a four-wire resistive touch panel 10 is depicted schematically. In the drawings, the touch panel 10 comprises a transparent substrate 11 and a cover sheet 12, wherein the transparent substrate 11 is a non-alkali glass substrate and the cover sheet 12 is a piece transparent sheet made of polyester. The transparent substrate 10 can be substantially planar to fit the face of the LCD panel or the planar-CRT, or can be contoured to match the face of a curved object such as the non-planar CRT. The substrate 10 can have any perimeter configuration, usually, rectangular, to match the configuration of the display.

FIG. 1 schematically depicts the transparent substrate 11 in a planar view. In the drawing, a resistive layer 110 of indium-tin oxide (ITO), zinc-tin oxide (ZTO), or other compounds is formed to overlay the transparent substrate 11. After subject to photolithographic and etching processes, the resistive layer 110 is patterned and etched to form a substrate peripheral region 111 in which a portion of the resistive layer 110 has been removed. Electrodes 112 and 114 are formed at opposite edges of the resistive layer 110. Conductive wires 116 and 118 are disposed in the substrate peripheral region 111 of the substrate 11 and connected to the electrodes 112 and 114, respectively. In FIG. 1, the wires 116 and 118 are traced from one side of the substrate 11 along the substrate peripheral region 111 to connect the respective electrodes 112 and 114 which are horizontally opposite-disposed.

FIG. 2 schematically depicts the cover sheet 12 in a planar view. In the drawing, a resistive layer 120 of indium-tin oxide (ITO), zinc-tin oxide (ZTO), or other compounds is formed to overlay the cover sheet 12. After subject to photolithographic and etching processes, the resistive layer 120 is patterned and etched to form a cover sheet peripheral region 121 in which a portion of the resistive layer 120 has been removed. Electrodes 122 and 124 are formed at opposite edges of the resistive layer 120. Conductive wires 126 and 128 are disposed in the cover sheet peripheral region 121 of the cover sheet 12 and connected to the electrodes 122 and 124, respectively. In FIG. 2, the wires 126 and 128 are traced from one side of the cover sheet 12 along the cover sheet peripheral region 121 to connect the respective electrodes 122 and 124 which are vertically opposite-disposed.

Referring to FIG. 3, a combination of the transparent substrate 11 and the cover sheet 12 is illustrated in a cross-sectional view. In FIG. 3, the cover sheet 12 is above the substrate 11 with a gap distance D such that the resistive layers 110 and 120 formed thereon face each other. Moreover, the cover sheet 12 is spaced apart from the substrate 11 by insulative spacers 13. Accordingly, the cover sheet 12 is so sufficiently flexible that selected points of the resistive layer 120 can be pressed into contact with the corresponding points of the resistive layer 110 of the transparent substrate 11. When orthogonal electrical fields can be produced by applying voltages to the electrode pairs 112-114 and 122-124, contact of the selected location with a finger or other object causes the generation of a signal that is representative of the X and Y coordinates of that specific point.

However, the conventional method makes use of the time-consuming photolithographic process (including sequential process steps of coating a photo-resistant layer, baking, development, rinse, etching, cleaning, removing the photo-resistant layer, post-baking, and so on) to pattern the resistive layers 110 and 120. In addition, because the thickness of the cover sheet 12 is significantly smaller than that of the substrate 11, the step of patterning the resistive layer 120 is quite sensitive to such heavy and complicated photographic process that may deteriorate production yield or shorten device lifetime.

### SUMMARY OF THE INVENTION

Therefore, it is an object of the present invention to provide a touch panel and a method for fabricating the same which patterns a resistive layer by means of an much inexpensive and simpler process without suffering from complicated process steps and yield deterioration

To attain this object, the present invention provides a touch panel comprising: a substrate; a first resistive layer formed on the substrate, the first resistive layer being divided into a first active region and a first peripheral region by a first trench; a pair of first electrodes formed at opposite edges of the first active region; a pair of first wires formed along the first peripheral region in contact with the pair of first electrodes, respectively; a cover sheet disposed above the substrate with a gap; a second resistive layer formed on the cover sheet, the second resistive layer being divided into a second active region and a second peripheral region by a second trench; a pair of second electrodes formed at opposite edges of the second active region; a pair of second wires formed along the second peripheral region in contact with the pair of second electrodes, respectively; and a plurality of insulative spacers formed within the gap between the cover sheet and the substrate.

In addition, the present invention provides a touch panel comprising: a substrate having a first resistive layer formed thereon; a cover sheet, formed above the substrate with a gap, having a second resistive layer formed thereon, the second resistive layer being divided into an active region and a peripheral region by a trench; and a plurality of insulative spacers formed within the gap between the cover sheet and the substrate.

Moreover, the present invention provides a method for fabricating a touch panel, which comprises the steps of: (a) providing a substrate having a first resistive layer formed thereon; (b) patterning the first resistive layer for forming a first trench to divide the first resistive layer into a first active region and a first peripheral region; (c) forming a pair of first electrodes at opposite edges of the first active region; (d) forming a pair of first wires along the first peripheral region in contact with the pair of first electrodes, respectively; (e) providing a cover sheet having a second resistive layer formed thereon, the cover sheet being above the substrate with a gap; (f) patterning the second resistive layer for forming a second trench to divide the second resistive layer into a second active region and a second peripheral region; (g) forming a pair of second electrodes at opposite edges of the second active region; (h) forming a pair of second wires along the second peripheral region in contact with the pair of second electrodes, respectively; and (i) forming a plurality of insulative spacers within the gap between the cover sheet and the substrate.

Furthermore, the present invention provides a method for fabricating a touch panel, which comprises the steps of: (a) providing a substrate having a first resistive layer formed thereon; (b) providing a cover sheet having a second resistive layer formed thereon, the cover sheet being above the substrate with a gap; (c) patterning the second resistive layer to form a trench to divide the second resistive layer into an active region and a peripheral region; and (d) forming a plurality of insulative spacers within the gap between the cover sheet and the substrate.

### BRIEF DESCRIPTION OF THE DRAWINGS

FIG. 1 depicts a transparent substrate of a conventional touch panel in a planar view;

FIG. 2 depicts a cover sheet of the conventional touch panel in a planar view;

FIG. 3 depicts the conventional touch panel in a cross-sectional view; and

FIG. 4 depicts a transparent substrate of a touch panel according to one preferred embodiment of the present invention in a planar view;

FIG. 5 depicts a cover sheet of the touch panel according to one preferred embodiment of the present invention in a planar view;

FIG. 6 depicts the touch panel according to one preferred embodiment of the present invention in a cross-sectional view; and

FIG. 7˜9 schematically depicts several examples of the trench

### DETAILED DESCRIPTION OF THE PREFERRED EMBODIMENTS

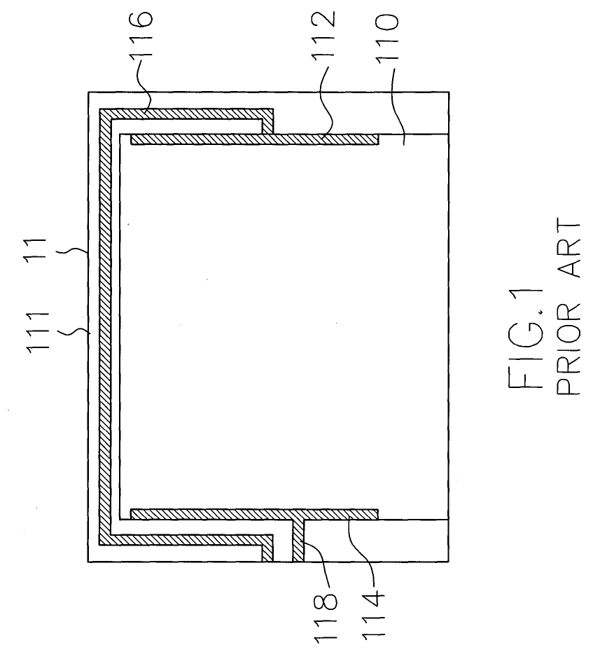

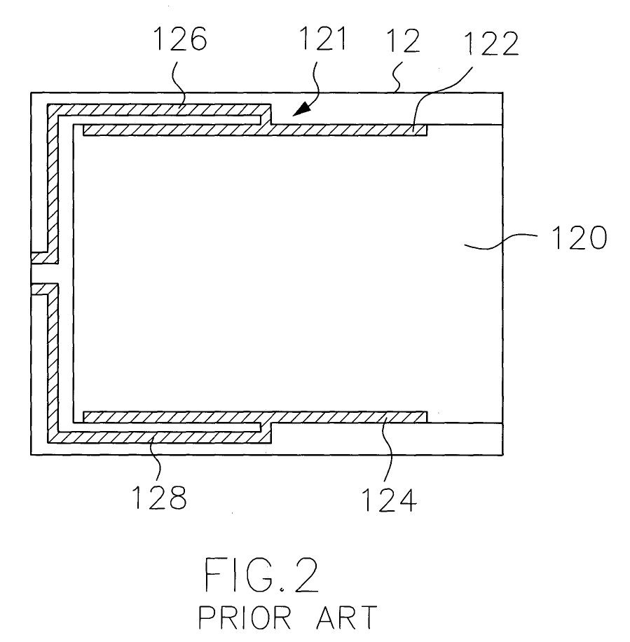

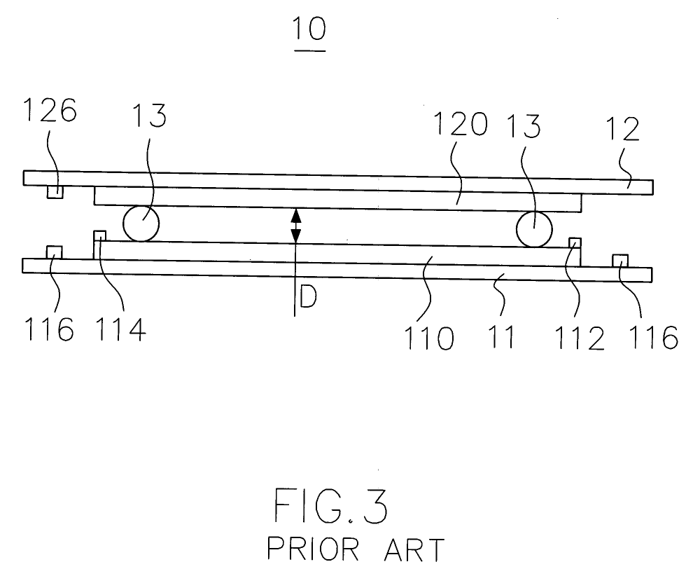

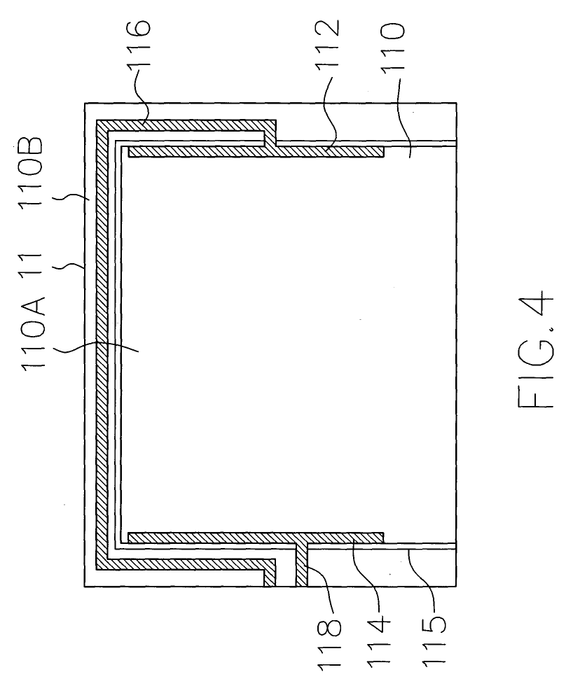

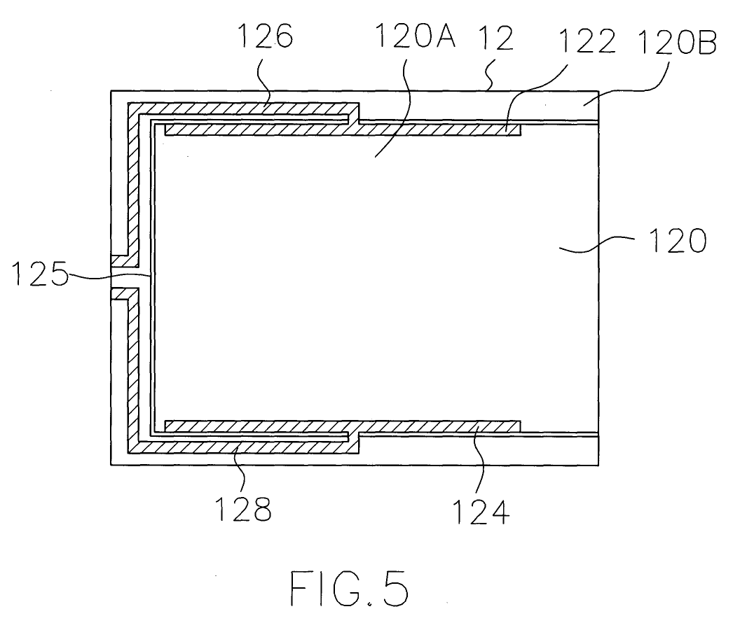

For the purpose of comparison, the reference numerals depicted in the following FIGS. 4˜6 the same as those of FIGS. 1˜3 represent the similar or corresponding parts.

First Embodiment

Referring to FIGS. 4˜6, a four-wire resistive touch panel 10 is depicted schematically. In the drawings, the touch panel 10 comprises a transparent substrate 11 and a cover sheet 12; preferably, the transparent substrate 11 can be a non-alkali glass substrate and the cover sheet 12 can be a piece transparent sheet made of polyester. Alternatively, the substrate 11 can be made of the same transparent material as that of the cover sheet 12. The transparent substrate 10 can be substantially planar to fit the face of the LCD panel or planar-CRT, or can be contoured to match the face of a curved object such as the non-planar CRT. The substrate 10 can have any perimeter configuration, usually, rectangular, to match that of the display.

FIG. 4 schematically depicts the transparent substrate 11 in a planar view. In the drawing, a resistive layer 110, preferably, of indium-tin oxide (ITO), zinc-tin oxide (ZTO), or other compounds, is formed to overlay the transparent substrate 11. Then, the resistive layer 110 is subject to laser processing to form a trench 115 from which a portion of the transparent substrate 11 is exposed. The trench 115 is employed to divide the resistive layer 110 into an active region 110A and a peripheral region 110B. In other words, the active region 110A and the peripheral region 110B are spaced apart from each other by a distance, that is, the width of the trench 115. Preferably, the laser processing can be implemented by Nd:YAG laser, Argon laser, CO₂ laser, Excimer laser, or the like. Electrodes 112 and 114 are formed at opposite edges of the active region 110A of the resistive layer 110. Conductive wires 116 and 118 are disposed within the peripheral region 110B of the resistive layer 110 and connected to the electrodes 112 and 114, respectively. In FIG. 4, the wires 116 and 118 are traced from one side of the resistive layer 110 along the peripheral region 110B to connect the respective electrodes 112 and 114 which are horizontally opposite-disposed. Preferably, the electrodes 112-114 and the wires 116-118 are formed by a physical vapor deposition (PVD) method, a chemical vapor deposition (CVD) method, a printing method, or the like. As well as the electrodes 112-114, the wires 116-118 are made of Ag, Cr, Mo, Al, or other metals.

FIG. 5 schematically depicts the cover sheet 12 in a planar view. In the drawing, a resistive layer 120, preferably, of indium-fin oxide (ITO), zinc-tin oxide (ZTO), or other compounds, is formed to overlay the cover sheet 12. Then, the resistive layer 120 is subject to laser processing to form a trench 125 from which a portion of the cover sheet 12 is exposed. The trench 125 is employed to divide the resistive layer 120 into an active region 120A and a peripheral region 120B. In other words, the active region 120A and the peripheral region 120B are spaced apart from each other by a distance, that is, the width of the trench 125. Preferably, the laser processing can be implemented by Nd:YAG laser, Argon laser, CO₂ laser, Excimer laser, or the like. Electrodes 122 and 124 are formed at opposite edges of the active region 120A of the resistive layer 120. Conductive wires 126 and 128 are disposed within the peripheral region 120B of the resistive layer 120 and connected to the electrodes 122 and 124, respectively. In FIG. 5, the wires 126 and 128 are traced from one side of the resistive layer 120 along the peripheral region 120B to connect the respective electrodes 122 and 124 which are vertically opposite-disposed. Preferably, the electrodes 122-124 and the wires 126-128 are formed by means of the physical vapor deposition (PVD) method, the chemical vapor deposition (CVD) method, the printing method, or the like. As well as the electrodes 122-124, the wires 126-128 are made of Ag, Cr, Mo, Al, or other metals.

As shown in FIGS. 4 and 5, the electrodes 112 and 114 are horizontally opposite-disposed on the resistive layer 110, where the electrodes 122 and 124 are vertically opposite-disposed on the resistive layer 120. However, such arrangement is not used to limit the scope of the present invention. For example, the electrodes 112 and 114 can be vertically opposite-disposed on the resistive layer 110, where the electrodes 122 and 124 can be horizontally opposite-disposed on the resistive layer 120 as long as orthogonal electrical fields can be generated thereby.

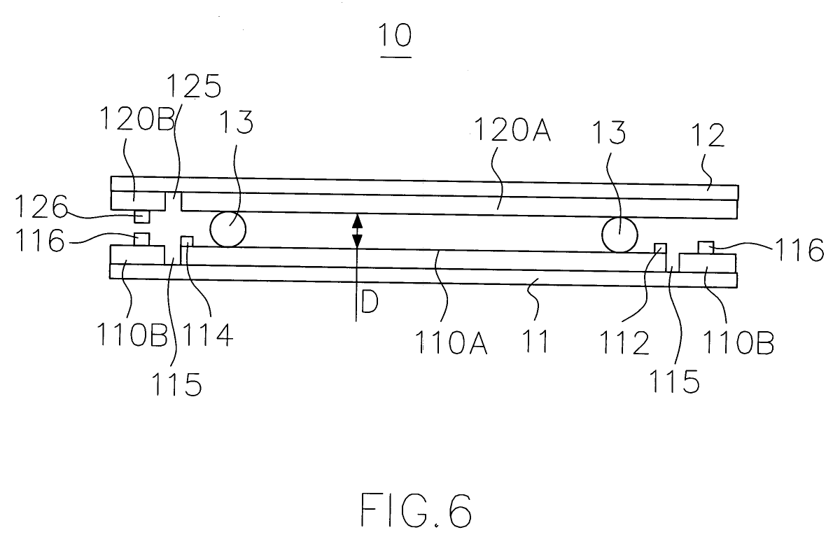

Referring to FIG. 6, a combination of the transparent substrate 11 and the cover sheet 12 is illustrated in a cross-sectional view. In FIG. 6, the cover sheet 12 is above the substrate 11 with a gap distance D such that the resistive layers 110 and 120 formed thereon can face each other. Moreover, the cover sheet 12 is spaced apart from the substrate 11 by insulative spacers 13. In other words, the insulative spacers are used to maintain the gap D between the substrate 11 and the cover sheet 12. The cover sheet 12 is so sufficiently flexible that selected points of the resistive layer 120 can be pressed into contact with the corresponding points of the resistive layer 110 on the transparent substrate 11. When the orthogonal electrical fields can be produced by applying voltages to the electrode pairs 112-114 and 122-124, contact of the selected location with a finger or other object causes the generation of a signal that is representative of the X and Y coordinates of that specific point.

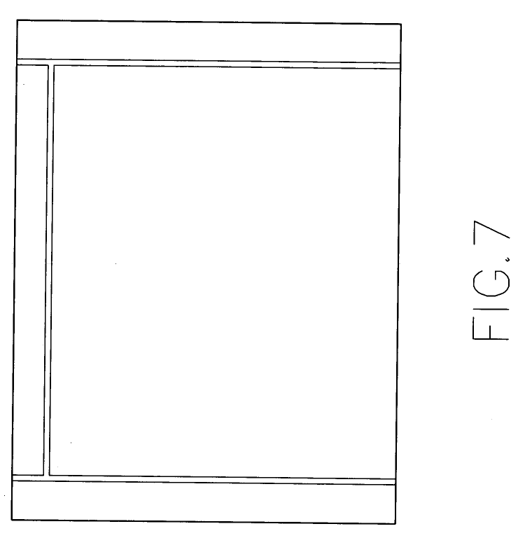

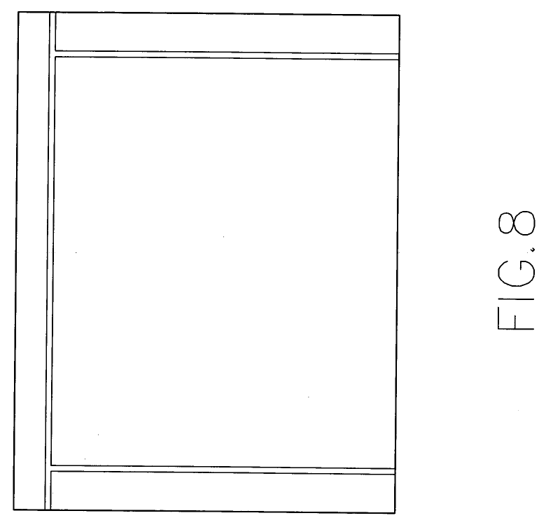

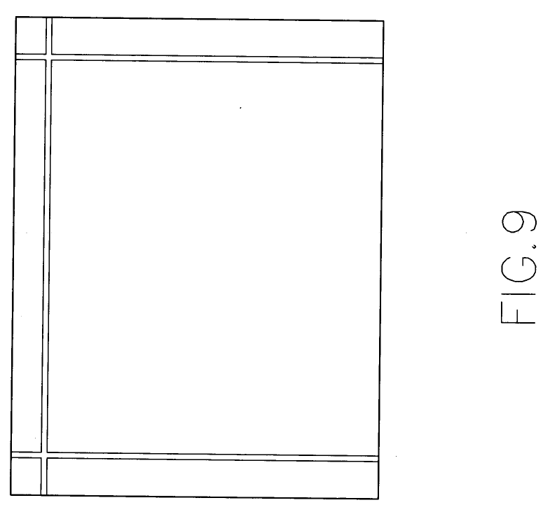

Though the trenches 115 and 125 are configured with an inverted-U shape, the scope of the present invention cannot be construed in such limiting sense. For example, an H-shape of FIG. 7, a 6-shape of FIG. 8, and a double-cross shape of FIG. 9 can be applied to the present invention, which are incorporated herein for reference.

According to the present invention, the resistive layers 110 and 120 are patterned by the laser processing to form the trenches 115 and 125 without subject to the photolithographic and etching processes. Therefore, the issues of complicated process steps and yield deterioration with which the conventional method is confronted can be avoided.

Second Embodiment

The method for fabricating a touch panel in accordance with another preferred embodiment of the present invention is described with reference to FIGS. 1˜3. In this embodiment, the resistive layer 110 is processed by laser to remove a portion thereof such that the substrate peripheral region 111 of the transparent substrate 11 can be exposed. Similarly, the resistive layer 120 is processed by laser to remove a portion thereof such that the cover sheet peripheral region 121 of the cover sheet 12 can be exposed. Accordingly, because the present invention makes use of the laser processing instead of the photolithographic and etching processes, the issues of complicated process steps and yield deterioration with which the conventional method is confronted can be avoided.

Although the description above contains much specificity, it should not be construed as limiting the scope of the invention but as merely providing illustrations of some of the presently preferred embodiments of the present invention. Thus, the scope of the present invention should be determined by the appended claims and their equivalents, rather than by the examples given.

What is claimed is:

1. A touch panel, comprising:
a substrate;
a first resistive layer formed on said substrate, said first resistive layer being divided into a first active region and a first peripheral region by a first trench;
a pair of first electrodes formed at opposite edges of said first active region;
a pair of first wires formed along said first peripheral region in contact with said pair of first electrodes, respectively;
a cover sheet disposed above said substrate with a gap;
a second resistive layer formed on said cover sheet, said second resistive layer being divided into a second active region and a second peripheral region by a second trench;
a pair of second electrodes formed at opposite edges of said second active region;
a pair of second wires formed along said second peripheral region in contact with said pair of second electrodes, respectively; and
a plurality of insulative spacers formed within said gap between said cover sheet and said substrate.

2. The touch panel as claimed in claim 1, wherein said substrate is a glass substrate and said cover sheet is a polyester sheet.

3. The touch panel as claimed in claim 1, wherein said first and second resistive layers are made of material selected from a group consisting of indium-tin oxide (ITO) and zinc-tin oxide (ZTO).

4. A touch panel, comprising:
a substrate having a first resistive layer formed thereon;
a cover sheet, formed above said substrate with a gap, having a second resistive layer formed thereon, said second resistive layer being divided into an active region and a peripheral region by a trench; and
a plurality of insulative spacers formed within said gap between said cover sheet and said substrate.

5. The touch panel as claimed in claim 4, further comprising:
a pair of electrodes formed at opposite edges of said active region; and
a pair of wires formed along said peripheral region in contact with said pair of electrodes, respectively.

6. The touch panel as claimed in claim 4, wherein said substrate is a glass substrate and said cover sheet is a polyester sheet.

7. The touch panel as claimed in claim 4, wherein said first and second resistive layers are made of material selected from a group consisting of indium-tin oxide (ITO) and zinc-tin oxide (ZTO).

8. A method for fabricating a touch panel, comprising the following steps of:
(a) providing a substrate having a first resistive layer formed thereon;
(b) patterning said first resistive layer for forming a first trench to divide said first resistive layer into a first active region and a first peripheral region;
(c) forming a pair of first electrodes at opposite edges of said first active region;
(d) forming a pair of first wires along said first peripheral region in contact with said pair of first electrodes, respectively;
(e) providing a cover sheet having a second resistive layer formed thereon, said cover sheet being above said substrate with a gap;
(f) patterning said second resistive layer for forming a second trench to divide said second resistive layer into a second active region and a second peripheral region;
(g) forming a pair of second electrodes at opposite edges of said second active region;
(h) forming a pair of second wires along said second peripheral region in contact with said pair of second electrodes, respectively; and
(i) forming a plurality of insulative spacers within said gap between said cover sheet and said substrate.

9. The method as claimed in claim 8, wherein the step (b) is implemented by laser processing.

10. The method as claimed in claim 9, wherein said laser processing is implemented by a laser means selected from a group consisting of Nd:YAG laser, Argon laser, CO₂ laser and Excimer laser.

11. The method as claimed in claim 8, wherein the step (f) is implemented by laser processing.

12. The method as claimed in claim 11, said laser processing is implemented by a laser means selected from a group consisting of Nd:YAG laser, Argon laser, CO₂ laser and Excimer laser.

13. The method as claimed in claim 8, wherein said electrodes and wires are made of metal selected from a group consisting of Ag, Cr, Mo, and Al.

14. A method for fabricating a touch panel, comprising the following steps of:
(a) providing a substrate having a first resistive layer formed thereon;
(b) providing a cover sheet having a second resistive layer formed thereon, said cover sheet being above said substrate with a gap;
(c) patterning said second resistive layer to form a trench to divide said second resistive layer into an active region and a peripheral region; and
(d) forming a plurality of insulative spacers within said gap between said cover sheet and said substrate.

15. The method as claimed in claim 14, herein the step (c) is implemented by laser processing.

16. The method as claimed in claim 15, said laser processing is implemented by a laser means selected from a group consisting of Nd:YAG laser, Argon laser, CO₂ laser and Excimer laser.

17. The method as claimed in claim 14, further comprising:
forming a pair of electrodes at opposite edges of said active region; and
forming a pair of wires along said peripheral region in contact with said pair of electrodes, respectively.

18. The method as claimed in claim 17, wherein said electrodes and wires are made of metal selected from a group consisting of Ag, Cr, Mo, and Al.

19. A method for fabricating a touch panel, comprising the following steps of:
(a) providing a substrate having a first resistive layer formed thereon;
(b) patterning said first resistive layer to expose a peripheral region of said substrate by laser processing;
(c) forming a pair of first electrodes at opposite edges of said first resistive layer;
(d) forming a pair of first wires along said peripheral region of said substrate in contact with said pair of first electrodes, respectively;
(e) providing a cover sheet having a second resistive layer formed thereon, said cover sheet being above said substrate with a gap;
(f) patterning said second resistive layer to expose a peripheral region of said cover sheet by laser processing;
(g) forming a pair of second electrodes at opposite edges of said second resistive layer;
(h) forming a pair of second wires along said peripheral region of said cover sheet in contact with said pair of second electrodes, respectively; and
(i) forming a plurality of insulative spacers within said gap between said cover sheet and said substrate.

20. The method as claimed in claim 19, wherein the steps (b) and (f) are implemented by a laser means selected from a group consisting of Nd:YAG laser, Argon laser, CO₂ laser and Excimer laser.

21. The method as claimed in claim 19, wherein said electrodes and wires are made of metal selected from a group consisting of Ag, Cr, Mo, and Al.
